(19) United States
(12) Patent Application Publication
(10) Pub. No.: US 2019/0293826 A1
(43) Pub. Date: Sep. 26, 2019

(54) Studfinder and Laser Level System

(71) Applicant: Elan Barram, Clearwater, FL (US)

(72) Inventor: Elan Barram, Clearwater, FL (US)

(21) Appl. No.: 16/357,601

(22) Filed: Mar. 19, 2019

Related U.S. Application Data
(60) Provisional application No. 62/647,163, filed on Mar. 23, 2018.

(51) Int. Cl. G01V 3/08; H01F 7/02; G01V 3/15; G01B 3/02; G01C 9/28

(52) U.S. Cl. CPC G01V 3/08; H01F 7/0294; G01C 9/28; G01B 3/02; G01V 3/15

(57) ABSTRACT

A stud-finding mechanism which is combinable or separately operable from a laser-level mechanism is disclosed. The two mechanisms can work separately or be combined into a single unit. The stud funding portion achieves its effects by focusing more on the metal in the stud than its wood content. Meanwhile, the level-indications are achieved by fluid containers with bubbles, but can also be projected onto a construction surface or decorative surface, thereby providing a convenient visual indicator of level-ness.

### BACKGROUND OF THE INVENTION

Conventional stud finders detect wood-studs but not necessarily metal. Often, such conventional systems do not detect wood-studs all that well, giving plenty of false hits and unreasonable output, often giving false-positive indicators on metal objects but where there are in fact no studs.

Next, drywall is typically mounted onto wooden studs using metal screws. A typical distance between studs is 16″, although sloppy or sub-standard construction variations cause this well-established construction-standard to sometimes not be adhered to. Also, other stud-distances are also prevalent, such as 24″.

To address these and other issues, a more reliable stud-finding mechanism is desired.

### SUMMARY OF THE INVENTION

The embodiments herein are directed to a stud-finding mechanism which is combinable or separately operable from a laser-level mechanism. The two mechanisms can work separately, or be combined into a single unit.

The embodiments herein are meant to achieve at least two main purposes:
1) finding studs in situations where visually assessing stud-location is not possible; and
2) obtaining an indication of level-ness.

The embodiments herein achieve this in a variety of ways. The stud funding portion achieves its effects by focusing more on the metal in the stud than its wood content. Meanwhile, the level-indications are achieved by fluid containers with bubbles, but can able projected no9t a surface thereby providing a convenient visual indicator.

### BRIEF DESCRIPTION OF THE DRAWINGS

FIGS. 1A, 1B, and 1C illustrate a stud-finding mechanism with a level incorporated therein;

FIGS. 2A and 2B show underside views of the stud-finder mechanism;

FIGS. 3A and 3B show views of the stud-finder mechanism with ruler markings;

FIG. 4 shows an interior view of the stud-finder mechanism, including a cavity for the magnet, along with a compartment for containing a bubble level mechanism;

FIG. 5 shows an example magnet;

FIGS. 6A, 6B, and 7 show views of laser mechanism;

FIGS. 8A and 8B show various views of the laser mechanism including where one or more metal plates may be positioned;

FIG. 9A shows detail of the push-button micro switch;

FIG. 9B shows detail of the adjustable lens;

FIG. 10 shows detail of the metal plate;

FIGS. 11, 12, 13, 14A, 14B, and 15 show a combination of the stud-finder mechanism magnetically connected to the laser mechanism;

FIGS. 16-17 show an embodiment in which two laser mechanisms can be attached to a single central stud-finder mechanism which is referred to as a “triple”;

FIGS. 18, 19, and 20 are flowcharts showing method of assembly and methods of use;

FIGS. 21A, and 21B illustrate actual usages of the embodiments herein; and

FIGS. 22A and 22B shows a horizontal or vertical line 2200 that can be projected onto a wall or other construction surface or decorative surface.

### DETAILED DESCRIPTION OF THE PREFERRED EMBODIMENTS

### Overview and Groupings of Drawings for Clarity

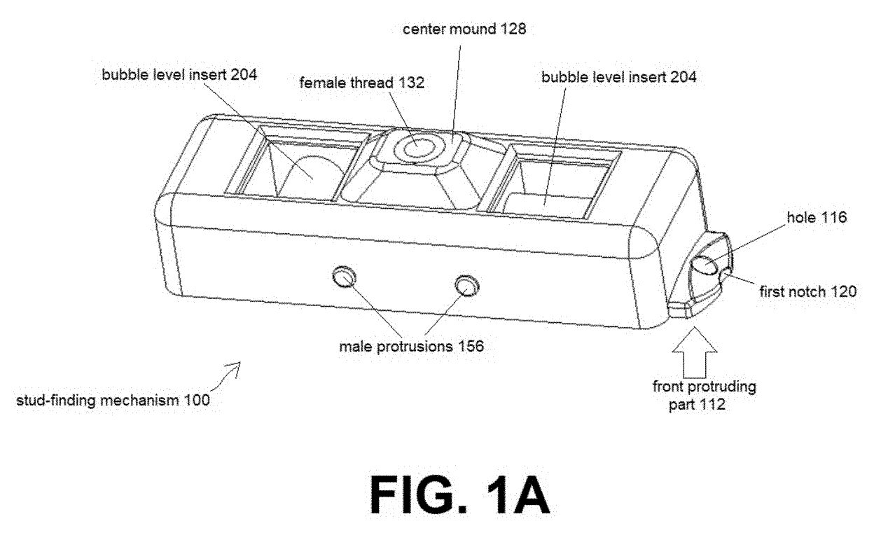

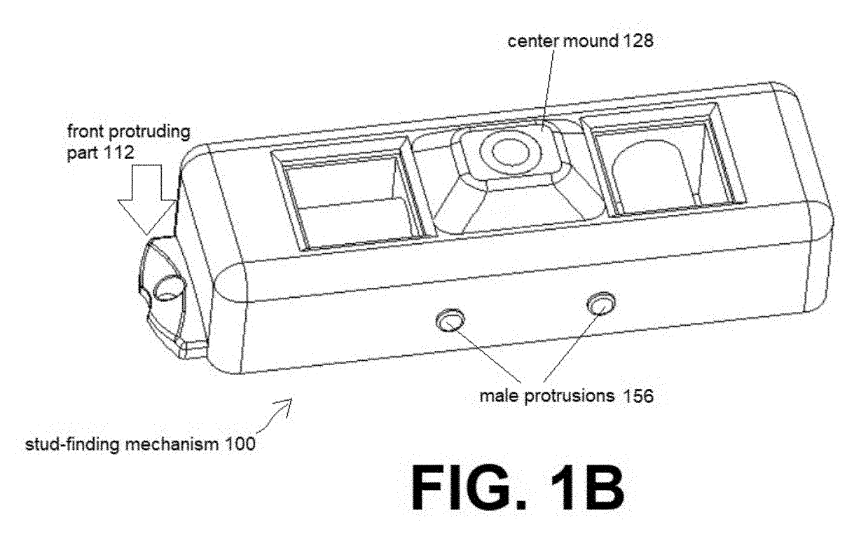

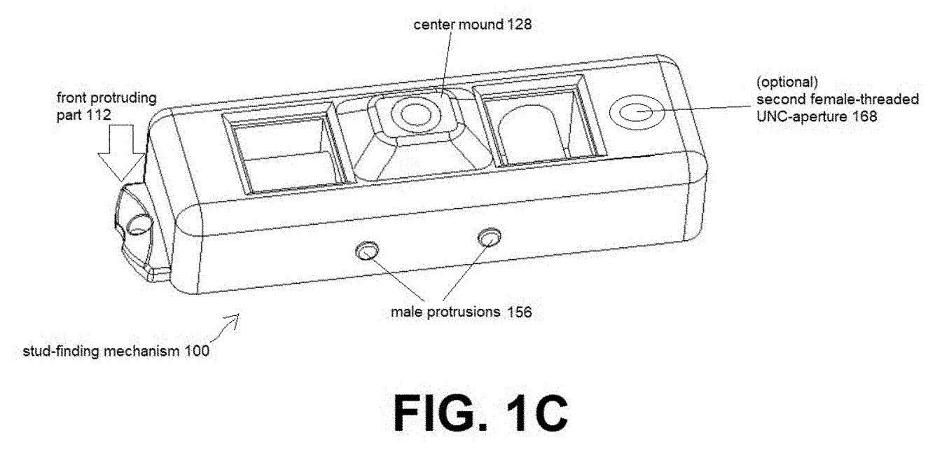

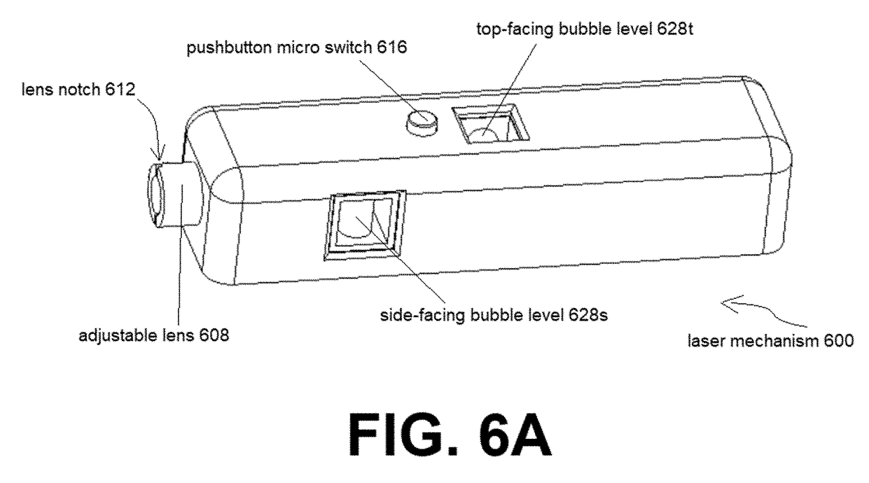

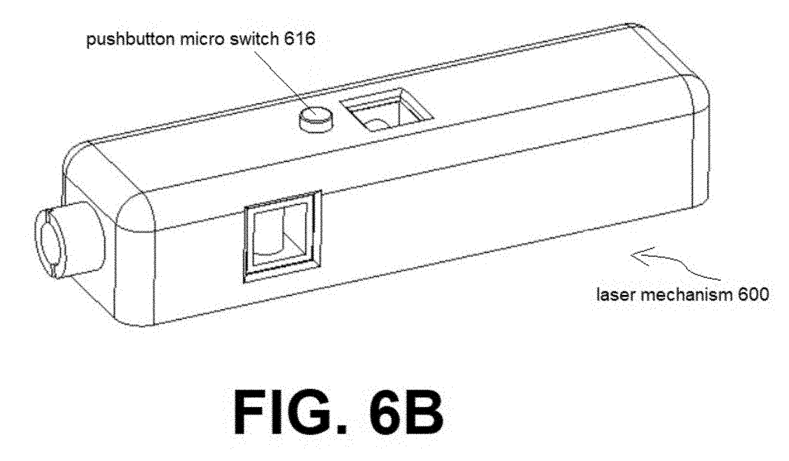

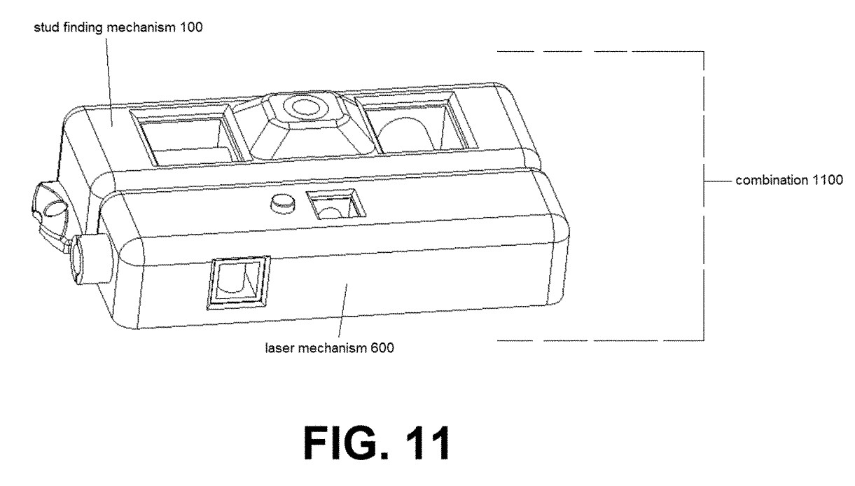

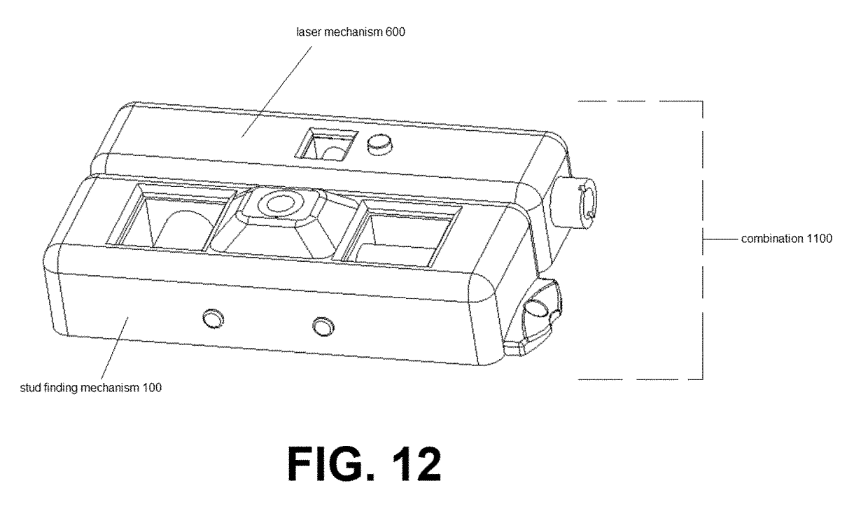

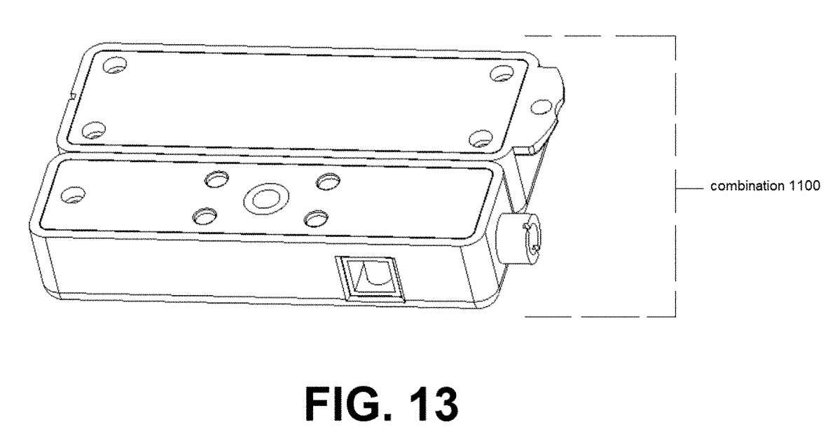

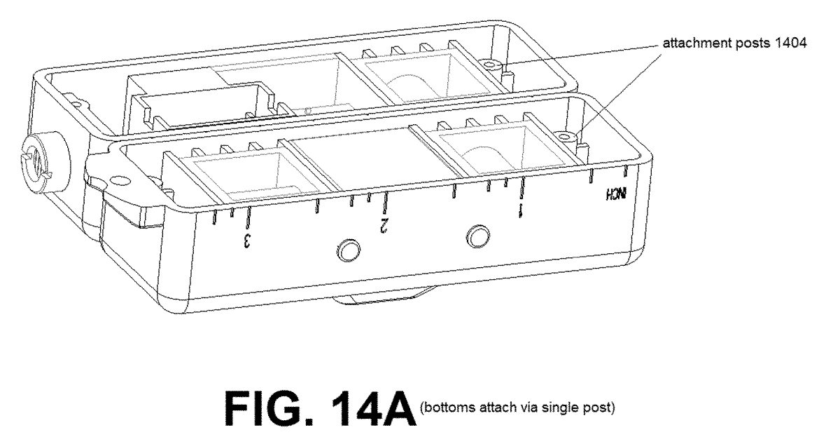

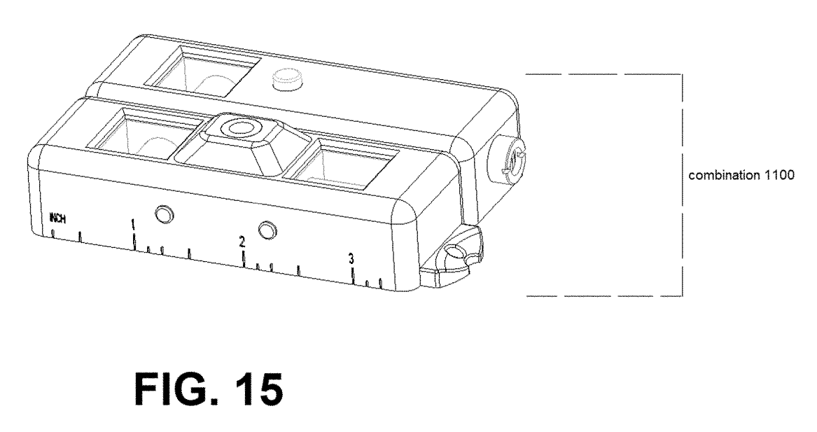

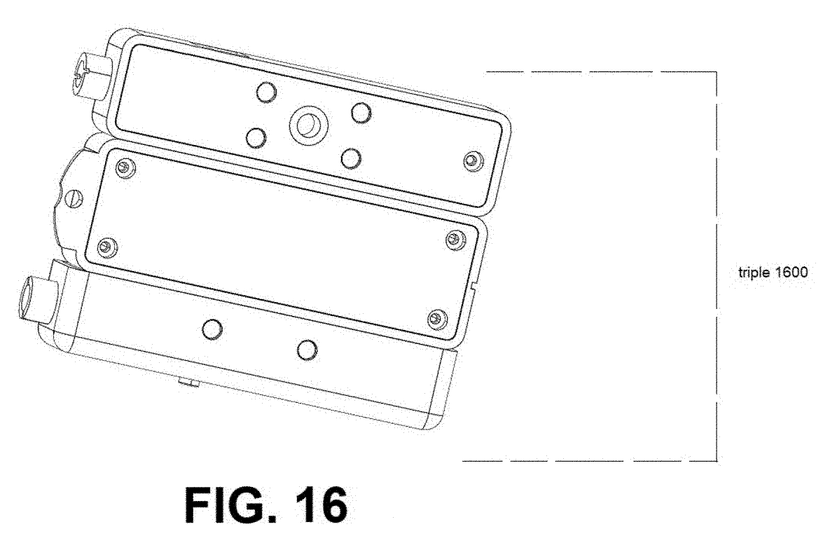

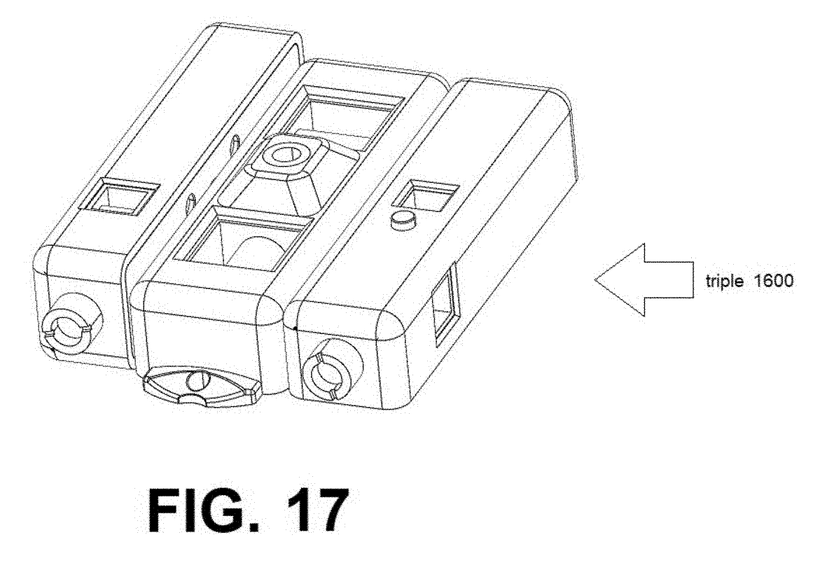

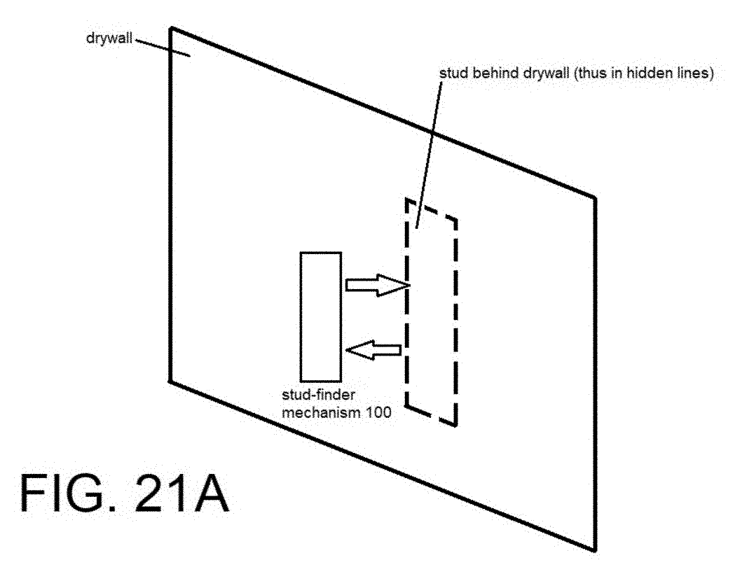

FIGS. 1-5 illustrate a stud-finding mechanism 100 (with a level incorporated therein). FIGS. 6-10 illustrate a laser mechanism 600. FIGS. 11-15 illustrate various components of both, including being combined into a dual-system combination 1100. FIGS. 16-17 show an embodiment in which 2 laser mechanisms 600 can be attached to a single stud-finder mechanism 100, at least for carrying and transport if nothing else. This will be referred to as a “triple”.

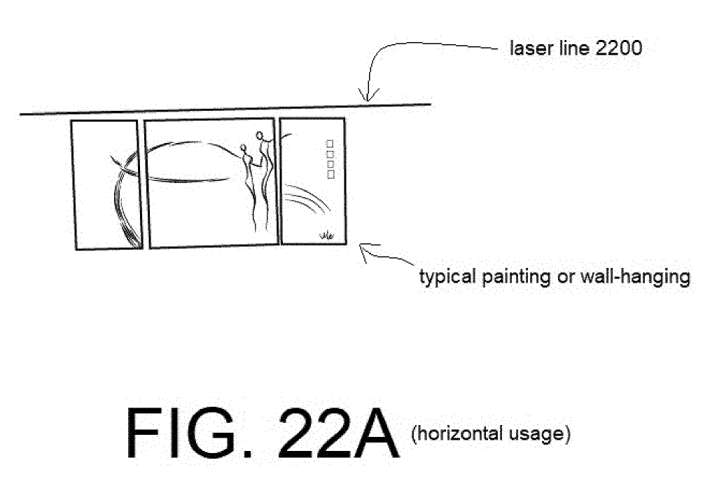

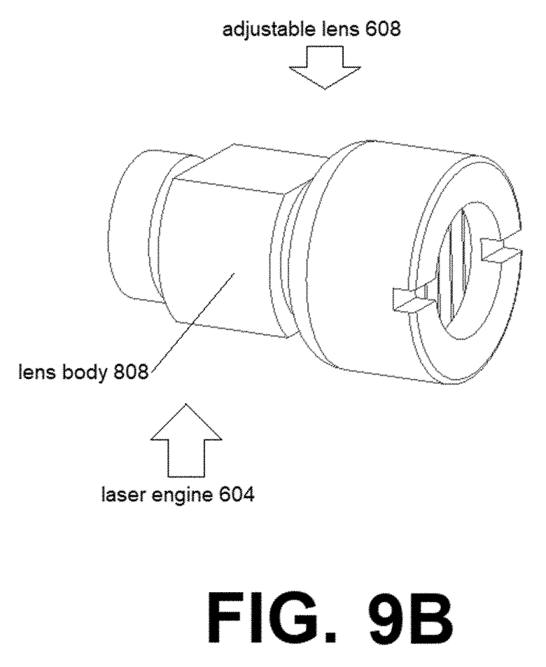

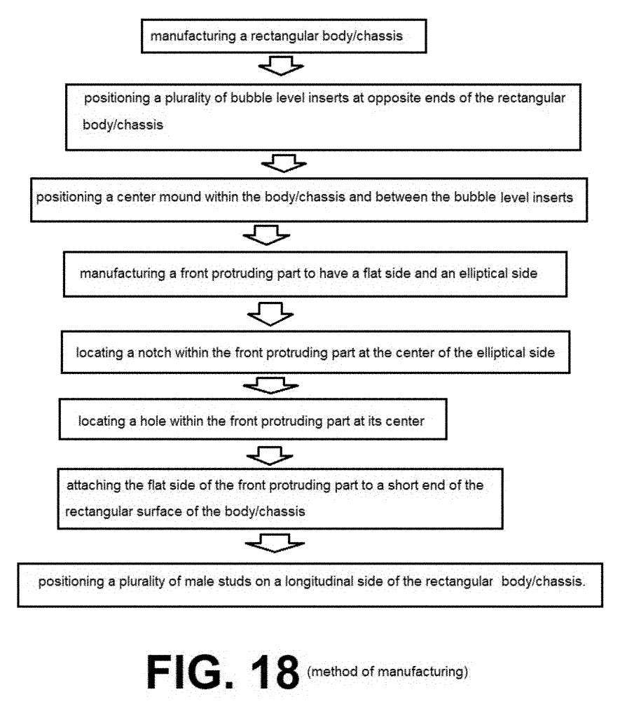

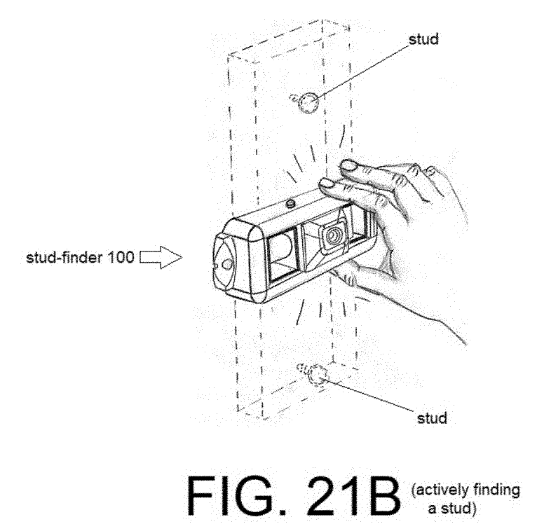

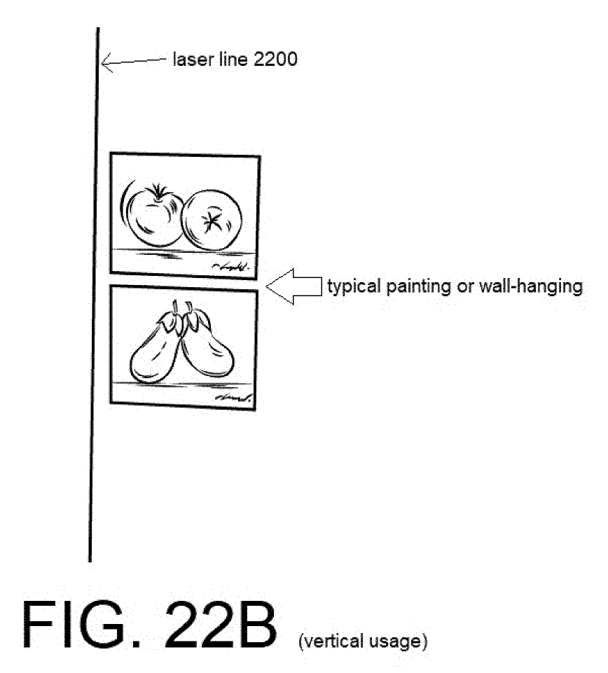

FIGS. 18-20 are flowcharts showing method of assembly and methods of use, and FIGS. 21-22 illustrate actual usages of the embodiments herein.

### Clarification\Semantics

The embodiments herein will largely consist of the stud-finding mechanism 100 and the laser mechanism 600, and in most embodiments, joined together into a single unit product. However, for clarity and explanation of manufacturing processes, the mechanisms 100/600 will sometimes be shown apart. Further, the mechanisms 100/600 can sometimes be used separately.

The stud-finding mechanism 100 will be referred to as a studfinder unit, but in an embodiment also has two level indicators 204 contained therein. Thus, it may seem confusing to refer to the stud-finding mechanism 100 only as a studfinder, because it does other functions. But for convenient reference, the expression “studfinder” will be used, because it will always have at least that function. Similarly, the laser mechanism 600 has also multiple functions, including level-finding, but for simplicity will be referred to as the laser mechanism 600, because it will always have that function.

### BEGIN DETAILED DESCRIPTION

By placing a stud-finding mechanism 100 against a wall or drywall and moving it across and around the drywall, one can easily and quickly locate nails and screws located within the studs and are hidden behind the drywall. By locating these metallic elements, the stud-finding mechanism 100 can locate the position of the studs. As such, the stud-finding mechanism 100 works differently than conventional stud finders, which detect wood-studs but not necessarily metal. And often, these conventional systems do not detect wood-studs all that well, giving plenty of false hits and unreasonable output, often giving false-positive indicators on metal objects but where there are in fact no studs.

The embodiments herein take advantage of the fact that drywall is typically mounted onto wooden studs using metal screws. A typical distance between studs is 16″, although sloppy or sub-standard construction variations cause this well-established construction-standard to sometimes not be adhered to. Also, other stud-distances are also prevalent, such as 24″. For safety, the location of studs can be confirmed by also measuring the distance between the distance of the screws found by the stud-finding mechanism 100.

To address these and other concerns, the stud-finding mechanism 100 comprises a strong magnet 104 inside the center of the case\chassis 102 and mounted directly on the bottom plate rear surface 180 of the body/chassis 102. This arrangement is shown at least within various of FIGS. 1-5. In an embodiment, the magnet 104 is built from neodymium, although the embodiments herein should not be considered as limited solely thereto. The magnet 104 will exert a substantial magnetic force. Further, the magnet 104 will be mounted inside the body/chassis 102 and will be able to detect nails and screws in wooden studs that are located behind drywalls. In an embodiment, the body/chassis 102 comprises acrylonitrile butadiene styrene (ABS).

As stated, metal screws are typically used to mount drywall sheets to studs. Thus, as a user swipes the stud-finder mechanism 100 over an area of drywall, that user will feel a magnetic pull when passing over a screw that is hidden behind the drywall in the stud. The magnet 104 is so strong that it will actually stay stuck to the wall (a user could even “let go” entirely) at the point where metal screws or other metal fastening mechanisms are detected. Examples of this swiping and usage activity are shown at least within FIGS. 21A and 21B.

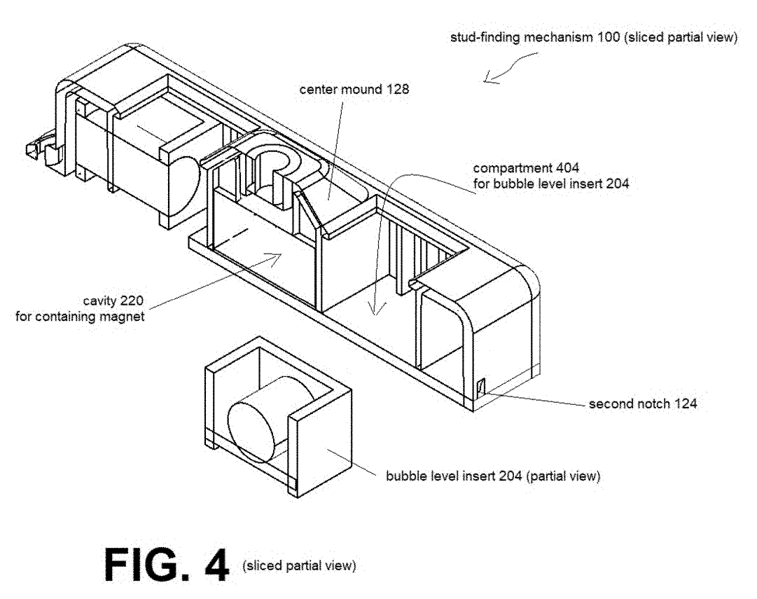

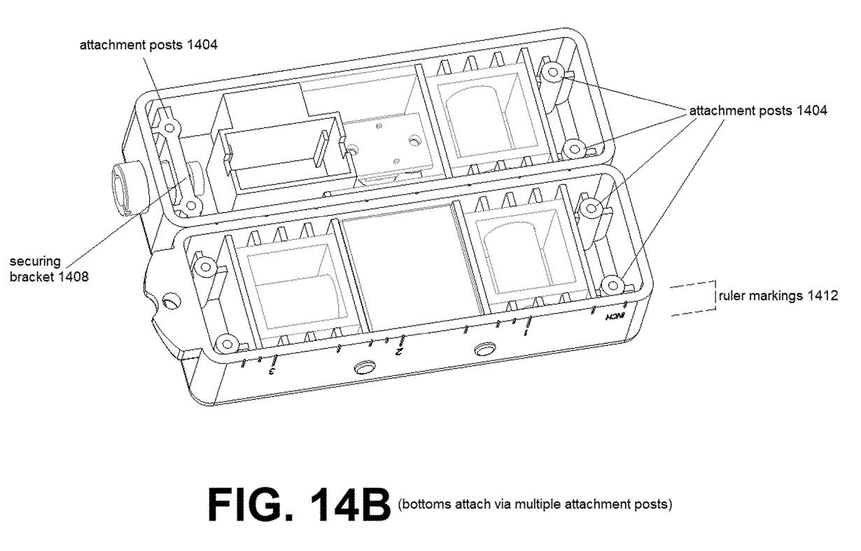

For at least this reason, the stud-finder mechanism 100 does not use batteries, and thus, as shown at least within FIGS. 4, 14A, and 14B, does not have a battery compartment. However, the various components of the stud-finder mechanism 100 could be re-arranged to accommodate a battery compartment if appropriate.

A front protruding part 112 of the stud-finder mechanism 100 has a hole 116 and a first notch 122. This notch 122 can be employed by a user to mark the position of a stud using a pen or pencil.

The hole 116 inside the front protruding part 112 can be used to tie a string to the stud-finding mechanism 100. This string can act as a plumb line, which can be hung, for example, from a nail or screw to determine the proper verticality of an object to be hung on a wall.

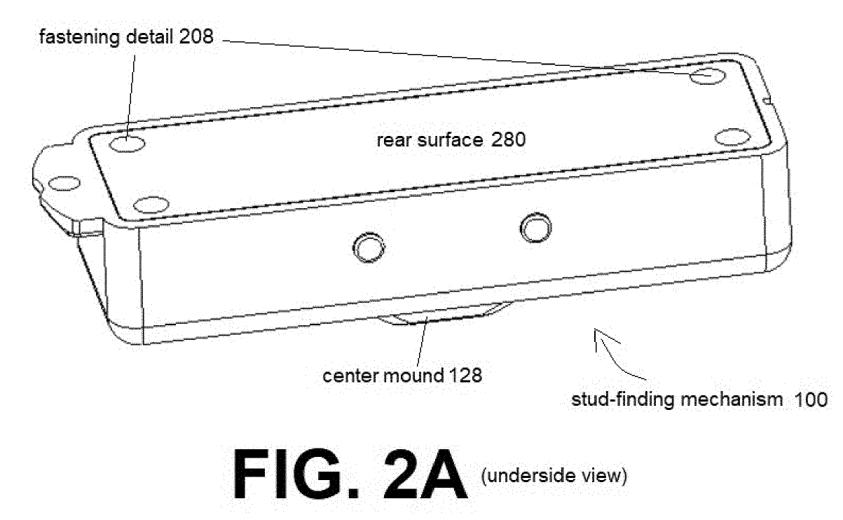

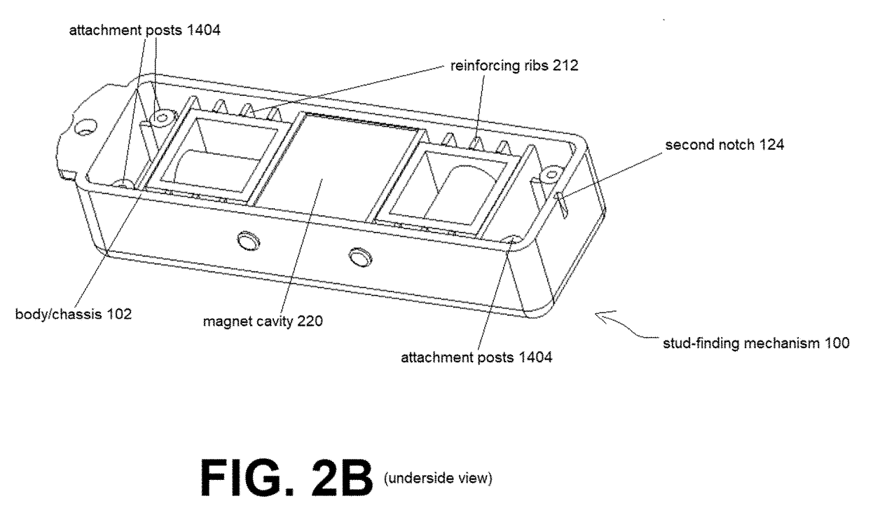

FIG. 2B shows an additional notch 124 located on the rear side of the stud-finding mechanism 100 which can be used to mark the position of a stud, using e.g. a pen or pencil.

The stud-finding mechanism 100 also contains a plurality of bubble level inserts 204 for checking\verifying proper horizontality\verticality of surfaces. In an embodiment, each bubble level insert 204 is configured to be 90 degrees from each other, so that one can check the level across two axes (e.g. horizontal and vertical, although other axes may also be considered). As such, various of the Figures herein show these bubble level inserts 204 perpendicular to each other, but other angles could also be used, or the bubble level inserts 204 could be movable for example rotatable.

As shown in FIGS. 1-4, the center mound 128 contains a female thread-coupling 132. In an embodiment, a 1/4-20 UNC can be used for the female thread coupling 132. This is advantageous because this is a standard per ISO 1222:2010 for cameras and tripods. This threading allows the stud-finder mechanism 100 to be mounted onto a standard tripod, selfie stick, or other male-threaded surface. Specifically, when one is needing to search for studs on walls or ceilings that are out of reach, one can attach the stud-finder mechanism 100 to an extended selfie stick and in this way one can scan walls and ceilings that would normally be non-accessible.

Alternatively, one could use a standard camera clamp which also equipped with a standard 1/4-20 UNC male thread mount and in this way the stud-finder mechanism 100 could attach to any pole, short or long. Further, as shown in FIG. 1C, an optional embodiment exists in which a second female-threaded UNC aperture 168 is located on the top surface of the stud-finder mechanism 100. Alternately, this second female-threaded UNC aperture 168 can be located on other surfaces of the stud-finder mechanism 100.

Regarding the front protruding part 112, in an embodiment, the length can extend out a variety of distances, including but not limited to 9.699 cm. However, many other sizes could also be used, so that these measurements are provided for enablement and example only, so that the embodiments herein should not be considered as limited exclusively thereto.

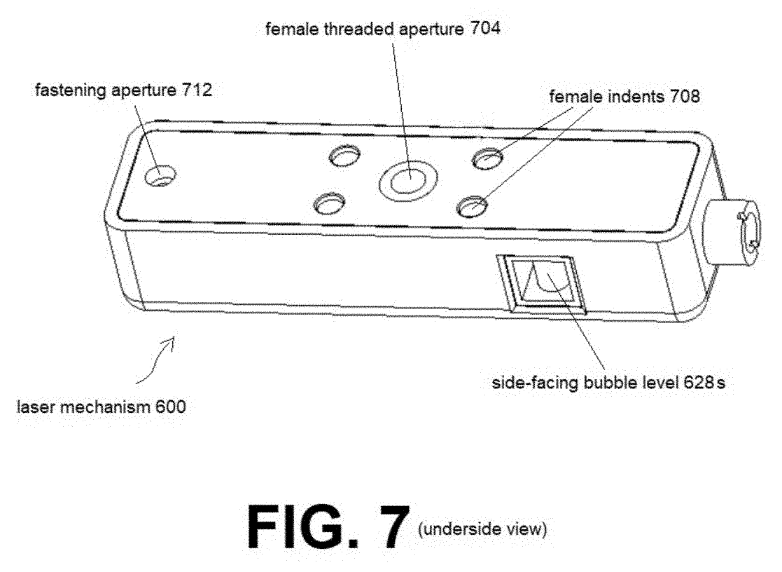

FIGS. 2A and 2B show underside views of the stud-finder mechanism 100, including a set of fastening details 208 and a rear surface 280. In the embodiment shown in FIGS. 2A and 2B, a total of four attachment posts 1404 are used to hold the rear surface 280 onto the body/chassis 102. However, other embodiments exist in which other amounts of attachment posts are implemented, for example in FIG. 7.

FIG. 4 shows an interior view of the stud-finder mechanism 100, including a cavity 220 for the magnet 104, along with a compartment 404 for containing a bubble level mechanism 204.

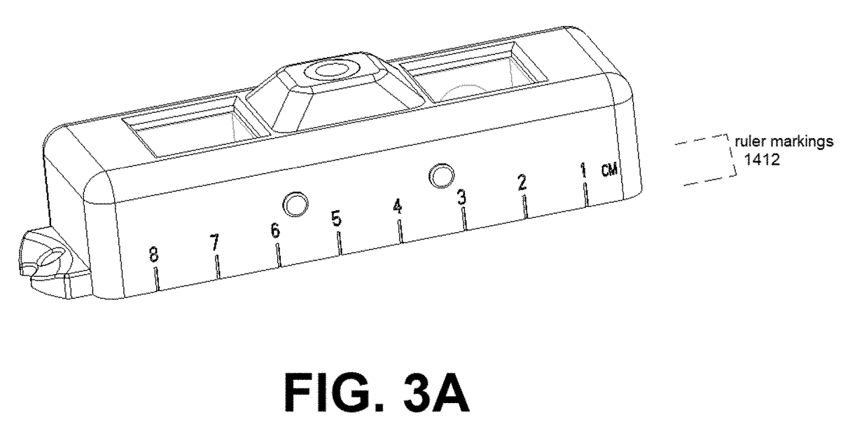

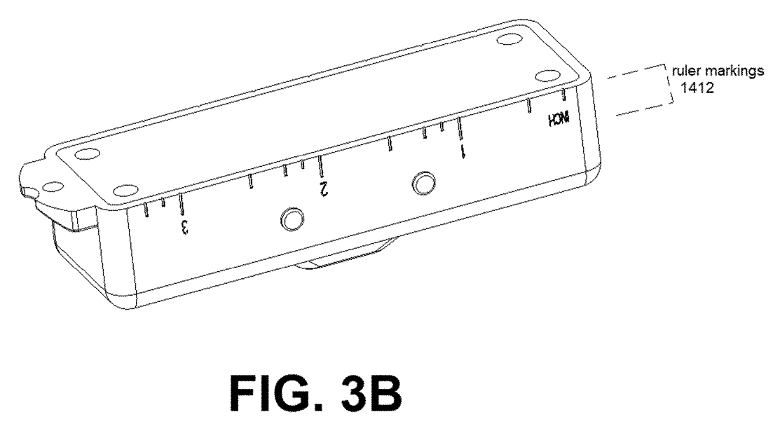

Along on one lengthwise side of the stud-finder mechanism 100, metric ruler markings 1412 show lines for cm and mm, along with numbers for cm, as shown at least within FIGS. 3A, 3B, 14A, and 14B. In an embodiment, along the opposite lengthwise side of the stud-finder mechanism 100 ruler markings 1412 show lines for inches and fractions of an inch along with numbers for inches.

As shown at least within FIGS. 1A, 1B, 2A, and 2B, along both long sides of the stud-finding mechanism 100 are two male protrusions 156 that stick out slightly. These are used to mate the stud finder mechanism 100 with the laser mechanism 600, as will be discussed in more detail elsewhere in this specification.

Moving back to the magnet 104, as stated, many types of magnetic elements could be used for the magnet 104, although an example embodiment uses neodymium. A neodymium magnet (also known as NdFeB, NIB or Neo magnet, a type of rare-earth magnet is a permanent magnet made from e.g. an alloy of neodymium, iron and boron to form a Nd2Fe14B tetragonalcrystalline structure. Neodymium magnets are considered to be strong permanent magnet among those that are commercially available. Neodymium magnets have only recently become affordable for everyday use. The expression NdFeB or NIB arises from being composed mainly of Neodymium (Nd), Iron (Fe) and Boron (B).

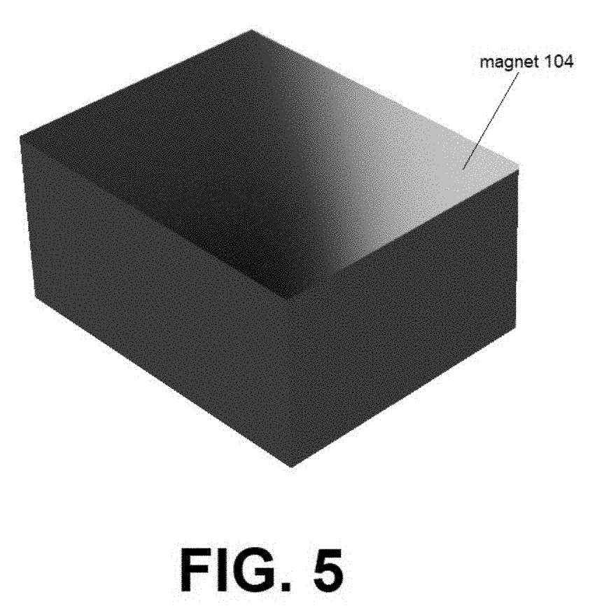

FIG. 5 shows an example magnet 104. Neodymium magnets are strength-graded by the specific material they are made of. As a very general rule, the higher the grade (the number following the ‘N’), the stronger the magnet. The highest grade of neodymium magnet currently available is N52. Any letter following the grade refers to the temperature rating of the magnet. If there are no letters following the grade, then the magnet is composed of standard temperature neodymium. The temperature ratings are standard (no designation)-M-H-SH-UH-EH. A stronger magnet means higher accuracy of the stud-finding capability of the stud-finding mechanism 100.

The magnet 104 is typically a rare earth magnet. This is advantageous because rare earth magnets have a high resistance to demagnetization, unlike most other types of magnets. Further, rare earth magnets will not lose their magnetization around other magnets, or if dropped. Neodymium magnets are typically over 10× stronger than the strongest ceramic magnets. Thus, the embodiments disclosed herein are advantageously configured for magnetic strength.

Moving onto the laser mechanism 600 shown at least within FIGS. 6-10, the laser mechanism 600 comprises a body/chassis 602, a laser engine 604, and a lens 608 in front of the laser engine 604. The lens 608 converts the laser beam into a horizontal or vertical line 2200 that can be projected onto a wall or other construction surface or decorative surface as shown at least within FIGS. 22A and 22B. The lens 608 can be rotated for calibration purposes. If a projected the horizontal line is not perfectly level (horizontal), the lens can be adjusted or rotated, so as to align with a water level. For example, the lens 608 can be rotated, but not to widen the laser line 2200. The rotation is for calibration of the laser line emitted therefrom, to ensure that laser line properly matches up with a level reading indicated within the bubble level 628.

As stated earlier, the laser mechanism 600 may be operated independently of the stud-finding mechanism 100, and vice versa.

The laser mechanism 600 further comprises a plurality of reinforcing ribs 812, a battery compartment 830, a push micro switch 616 on the top of the laser to turn the laser on/off, and a top-facing bubble-level 628t on the top of the laser mechanism 600 which enables a user to ensure that the projected horizontal line remains level. The reinforcing ribs 812 have two purposes. A first purpose is to assist the mechanical integrity of the body/chassis 602 during use. A second purpose is to make the molding and method of manufacture of the body/chassis 602 to proceed more quickly and at less expense, while still protecting mechanical integrity of the device and reducing breakdowns and failures. For example, the reinforcing ribs 812 can be used to help “pop out” the body/chassis 602 out of its mold (if molded).

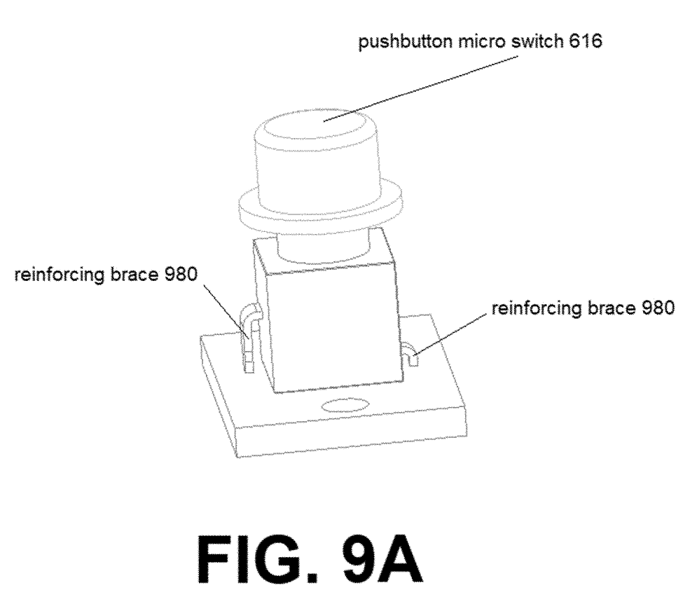

FIG. 9A shows detail of the pushbutton micro switch 616. As shown in FIG. 9A, the pushbutton micro switch 616 has at least two reinforcing braces 980 to help keep it stable and remain in place. The pushbutton micro switch 616 is one of the few parts on the laser mechanism 600 that will be repeatedly subject to human contact, so its ability to withstand forces must be achieved. Through experimentation and testing, it was found to locate the two reinforcing braces 980 to be of different sizes and attach to the body at different heights.

As stated, it is a goal of the embodiments herein to make the molding and method of manufacture of the body/chassis 602 to proceed more quickly and at less expense, while still protecting mechanical integrity of the device and reducing breakdowns and failures. To address these and other issues, FIG. 9B shows detail of the laser engine 604 and adjustable lens 608, including the lens body 808. The shape of the lens body 808 is explicitly chosen to be quickly and easily inserted into the body/chassis 602, and also to facilitate effective routing of wires. Specifically, during the initial manufacture and assembly of the laser mechanism 600, the routing of wires between the laser engine 604 and the battery compartment 830 are of particular concern. To address this, the laser engine 604 is inserted into the body/chassis 602 using a mechanism that lifts the various wiring components out of the way and makes it more accessible to be later routed and connected to the battery compartment 830.

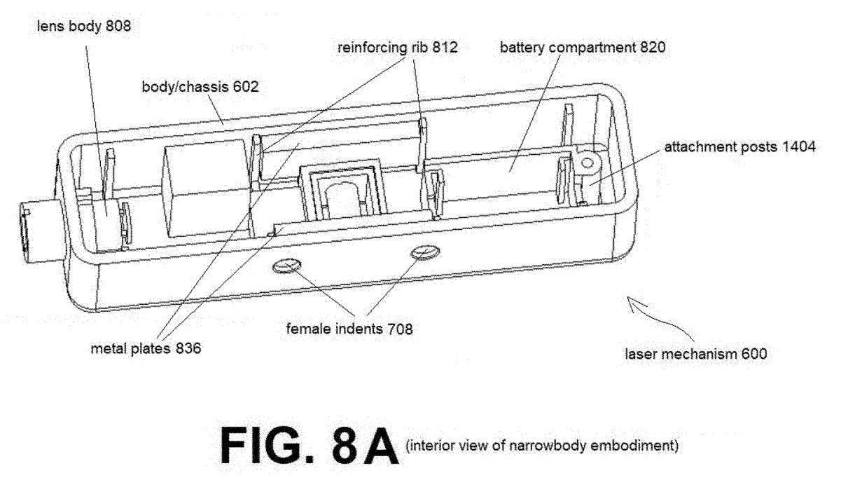

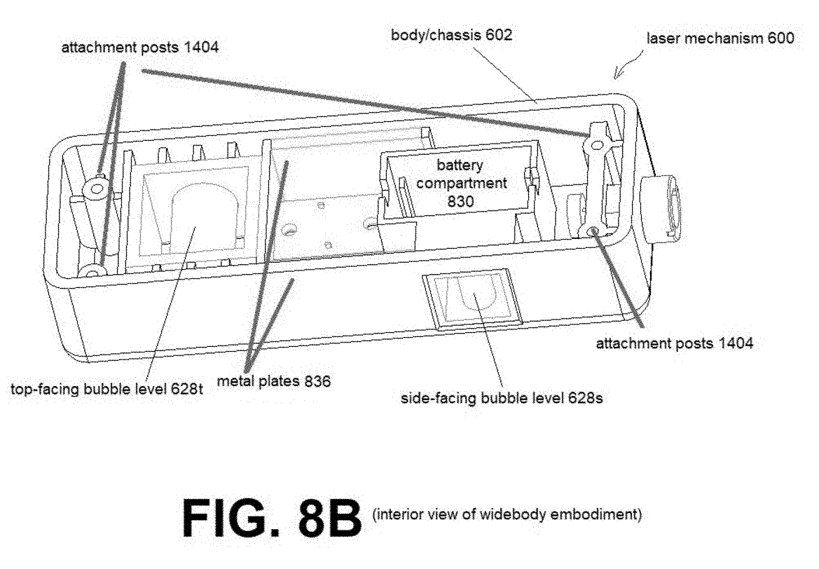

A side-facing bubble level 628s is located within a side (not top) of the laser mechanism 600. As shown at least within FIGS. 7, 8A, and 8B, the bubble levels 628t and 628s may or may not be different sizes. Similarly, the switch 616 could be other sizes and dimension that what is shown in the drawings. Again, as stated, the various drawings should be interpreted as for example purposes only, and thus not limited only to what is shown therein.

The laser mechanism 600 supports rotation by 90 degrees to project a vertical line 2200 (see FIG. 22B).

The side-facing bubble-level 628s can be used to ensure the projected vertical laser line 2200 is level. In an embodiment, the bubble-levels 628 may be water-based, but also may have some other fluid located therein. For example, in military environments, e.g. Iraq, Syria, Afghan, the intense heat could cause water to leak or evaporate. Accordingly, a variety of other non-aqueous fluid substances could also be used for the bubble level 628, including gels and suspensions of varying composition and varying viscosity. A non-fluid mechanism such as an electronic mini-accelerometer and gravity sensor the size of a grain of rice could be used for bubble-levels 628 (which thus may nor may not have bubbles), which is capable of functioning in any temperature/pressure/humidity environment, including within outer space vessels, space-station, or SpaceX projects.

There is also an issue that the bubble-mechanisms 628 may not work well in limited-light environments, while an electronic level mechanism (not shown) can include some type of electronic display (rather than a fluid-bubble tube mechanism). Thus, the expression bubble-level is used for convenient understanding only, so that the embodiments herein should not be considered as limitedly solely to bubbles and fluid, although that is one proposed embodiment.

As shown at least within FIG. 7, at a bottom of the laser mechanism 600 is a 1/4-20 UNC female threaded hole 704. This is used for mounting the laser mechanism 600 on any standard tripod or camera mounting device. The laser mechanism 600 can be mounted onto a tripod and in this way the laser line can be projected against a wall. Again, this fits with the principle that the laser mechanism 600 may be operated independently of the stud-finding mechanism 100.

The laser mechanism 600 can be mounted onto a camera clamp device and in this way be mounted to a ladder, a shelf unit, a table or any similar type of object and from that point can project a laser line onto a wall. As shown at least within FIGS. 22A-22B, the bubble levels 628 on the laser mechanism 600 are used to ensure the projected laser line 2200 is level.

As shown in FIGS. 7, 8A, and 8B, female apertures 708 are located on the side and on the bottom of the laser. These female apertures 628 mate with the protrusions 156 located within the stud-finding mechanism 100, and are used to pair up the laser mechanism 600 with the stud-finder mechanism 100. Further, the embodiment in FIG. 7 shows only a single fastening aperture 712, which matches up with a fastening post (not shown in FIG. 7). However, as stated, numerous other arrangements of fastening apertures and fastening posts can be used, so that the drawings are for illustration rather than definite limits. For example, at least FIGS. 2A, 3B, and 14 either show or imply four fastening posts.

After experimentation and testing, it was discovered that the battery compartment can be slightly offset from the female apertures 628, for strength and cost reduction in molding/manufacturing.

After experimentation and testing, it was discovered to specially mount the laser engine 608 a certain way within the body/chassis 602, to prevent the wires twisting and tearing.

In an embodiment, the bubbles within the stud-finder mechanism 100 can be varied in size e.g. larger than the bubbles within the laser mechanism 600. An example of this is shown in FIG. 11.

Further, the window of the of a particular bubble level might be bigger or smaller than what is shown in the drawings, and the pushbutton micro switch 616 might be a different size than what is shown in the drawings. Again, the embodiments shown in the drawings are for example only, enablement only, so that the exact proportions within the drawings should not be considered as limiting, but instead are only suggestions.

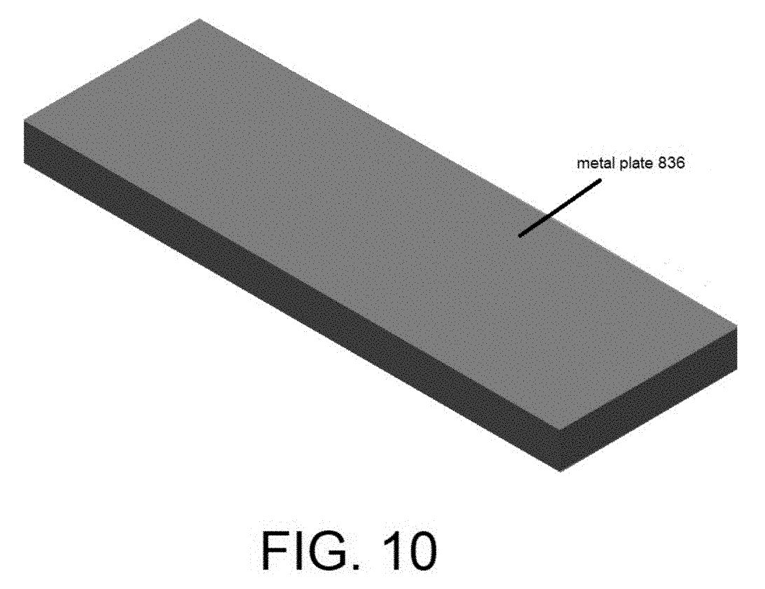

Next, one or more metal plates 836 may be positioned at various sides and locations of the laser mechanism 600 (see e.g. FIGS. 8A and 8B). These plates 836 are used to assist the magnet 104 in securely pairing the laser mechanism 600 with the stud-finder mechanism 100 including during use involving a lot of movement, attachment/detachment, shaking, and unusual construction situations where space is limited and availability of hands and fingers may also be limited. FIG. 10 shows detail of the metal plate. The magnetic force of the magnet 104 on the metal plates 836 will magnetically and securely attach the laser mechanism 600 to the body of the stud-finder mechanism 100, and keep the two mechanically combined. As will be demonstrated numerous places in this disclosure e.g. at least FIG. 11, the combination of stud-finder mechanism 100 magnetically connected to laser mechanism 600 will be referred to as “combination 1100”.

Meanwhile, in a non-restricting embodiment, a magnet plate (not shown) can also potentially be mounted somewhere inside of laser mechanism 600, which can be used to magnetically mount the laser to other metallic tools and objects, or to refrigerators.

As described earlier, the stud-finder mechanism 100 contains the magnet 104 which will keep the laser mechanism 600 attached thereto. The two male studs 156 on the stud-finder mechanism 100 pair up with the two female apertures 708 on the laser mechanism 600 to keep these perfectly aligned. As shown in FIGS. 11, 12, 13, 14A, 14B, and 15 (hereinafter, FIGS. 11-15), these mechanisms 100 and 600 can be paired up in different positions. Also as shown in FIGS. 11-15, the resulting combination will be referred to as combination 1100.

The advantage of pairing up these mechanisms 100 and 600 is that the resulting combination 1100 has additional bubble water levels and a stronger magnet. This allows the laser mechanism 600 to have a wider variety of usages. For example, the stud-finder mechanism 100 is magnetically mounted onto a metal plate that is mounted in a very specific angle and direction. The laser mechanism 600 can now be attached to the stud-finder mechanism 100, which can act as a positioning device for the laser mechanism 600 so that the resulting laser line 2200 projects in a desired direction.

The laser mechanism 600 can be mounted side by side with the stud-finder mechanism 100 to project a horizontal beam onto a surface where an indication of level is desired using the variety of female apertures 628. The laser mechanism 600 can be rotated 90 degrees and attached in this way to the stud-finder mechanism 100 to project a vertical line. The laser mechanism 600 can be flipped to project in the opposite direction and in this way be attached to the opposite side of the stud finder, again kept in place through the studs and holes and the magnetic force.

FIGS. 16-17 show two laser mechanisms 600 each attached to a central stud-finder mechanism 100, in a configuration referred to herein as a triple 1600. While it's unlikely this configuration would be used exactly as shown, it is possible it would be used for transport or for convenient organization.

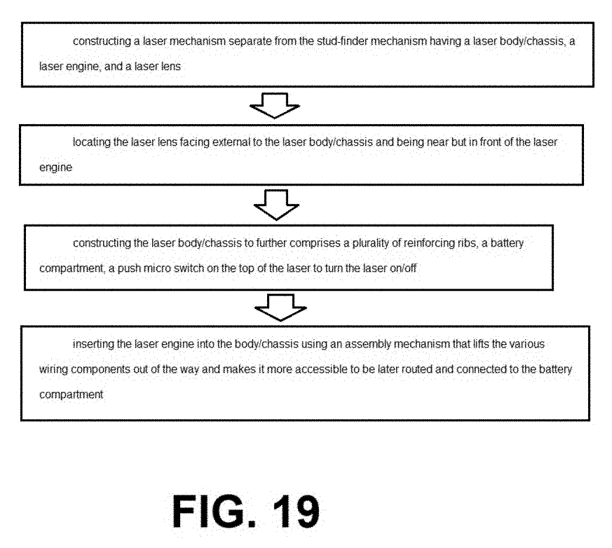

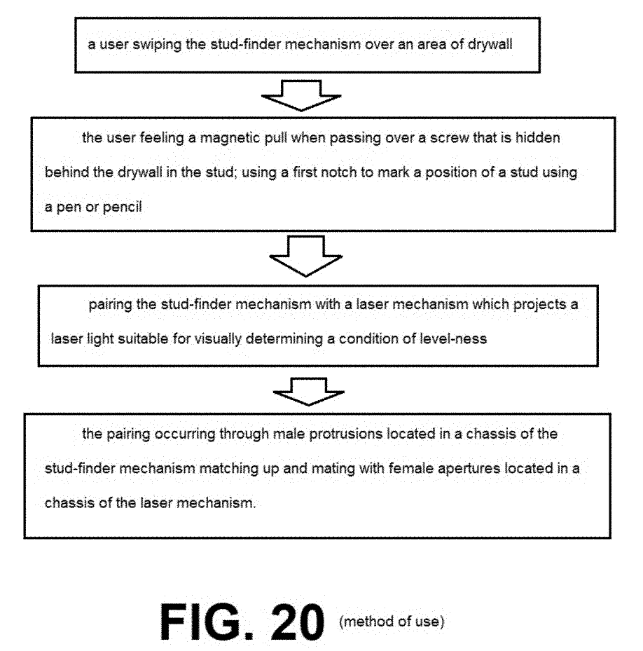

FIGS. 18-20 are flowcharts showing methods of manufacture and method of use of the embodiments herein. Specifically, FIG. 18 shows an example partial, non-limiting method of manufacture of the stud-finder mechanism 100. FIG. 19 shows an example partial, non-limiting method of manufacture of the laser mechanism 600. FIG. 20 shows an example partial, non-limiting method of use of the stud-finder and laser mechanisms 100\600.

FIGS. 21A and 21B show partial, non-limiting potential methods of usage of the stud-finder device 100.

As shown at least within FIGS. 22A-22B, the bubble levels 628 on the laser mechanism 600 are used to ensure the projected laser line 2200 is level, either horizontal (FIG. 22A) or vertical (FIG. 22B).

### ADDITIONAL EMBODIMENTS

The stud finder's magnet in the base and its magnetic force can be used to pick up screws, nails, washers and other similar items. It can be used in this way to pick up screws inside tool bags. With an extended arm attached to it, the magnet can also be used to pick up such items on the floor or behind walls through small openings where one's hand and arm cannot reach.

The stud finder's magnet located within its base, so it can be used to keep screws handy, organized, and easily accessible without dropping to the floor.

The stud-finder mechanism 100 can also use the strong magnet 104 in its base to magnetize screwdrivers. This is accomplished by rubbing the magnet 104 over the screwdriver repetitively. Further, the magnet 104 can be used to mount the stud-finder mechanism 100 or the combination 1100 to another surface e.g. a refrigerator, and thus be used for mounting, not solely for stud-finding.

In an embodiment, the stud-finder mechanism 100 (or another companion tool) can also act as a receiver to watch for the laser beam. For example, when the stud-finder mechanism 100 is on the exact line of the laser beam, an LED light indicator (not shown) could “turn on” to indicate the laser is properly “on the line”. This is somewhat similar to a laser tag game, i.e. when a person shoots a target (accurately), that target lights up. Also, imagine a garage door infrared beam that catches or triggers when the laser beam is broken. In such an arrangement, there are two parts, one part which sends the beam, and the other part receives it. This embodiment is similar, a sender and a receiver. For example, it is possible to have a tool that detects the laser beam when it is exactly in line of sight with the laser itself.

Additionally, an embodiment exists in which a tone (audible sound) indicates when the receiver is on the projected line. The stud-finder mechanism 100 acting as the receiver (or a new tool acting as the receiver), has notches on the ends, like the stud finder has, which can be used to mark points that are on the exact laser beam line.

In an embodiment, the combination 1100 can also include a live hot wire tester, which detects if an electrical line is hot. Additionally, the combination 1100 can also include a wire tone tester, one tool attaches to a wire and generates a tone signal. The other tool listens for the tone on the other end of the wire and makes a tone sound when put into vicinity of the wire. Construction projects often have many wires running through a building or a house. This feature allows identifying a particular wire that starts at one point and locate it at the other end, where otherwise, one cannot easily distinguish between the different wires.

Next, a larger version of the laser engine 604, similar to the current design but bigger with an even more powerful laser beam, can also be included. This version would be suitable for larger spaces having perhaps a higher degree of ambient light present. In such an instance, it may be difficult to see a lesser-powered laser. Such a feature would provide better illumination and visibility.

A user can magnetically attach the stud-finder mechanism 100 to a wall and using the bubble levels 204 therewithin, use that stud-finder mechanism 100 to sight-adjust the wall to be level (adjective). To calibrate the laser mechanism 600, a user will project the laser line onto the stud-finding mechanism 100. Using the grooves of both ends of the stud-finder mechanism 100, a user can now check the line to see that it is perfectly level and passes through both notches 122/124 on the ends of the stud finder. In addition, it is also possible to draw a line along the center to assist in this way for calibration of the laser mechanism 600.

For example, the laser mechanism 600 is shown in various of the Figures having a bubble level on the top 628t and also on one side 628s. However, these Figures should not be considering as limiting, but instead are for example and enablement only. For example, it is possible to also add an additional bubble level to the other side of the laser, so that the overall configuration maintains a symmetrical configuration.

Within the various Figures herein, a rotatable calibration lens 608 is shown on the outside of the ABS body (see e.g. FIG. 6A). However, the embodiment shown in FIG. 6A is for convenient illustration only, and the lens 608 could also be located inside the ABS body, flush-mounted, to reduce possibility of breakage or bumping. Locating the lens 608 outside makes it easy for the user/customer to calibrate, but also has a risk of it getting knocked about when it is in one's pocket or toolbox and this then causes the laser to go out of calibration. So, keeping it inside protects the case 120 against unwanted movement.

Within that flush-mounted embodiment, the laser engine 604 and lens 608 are interior to the laser mechanism 600 and do not have protruding surfaces. In such a case, to rotate the lens 608, it is possible for the lens 608 to have in the front two slots in its rim on two sides. A user could insert e.g. a flat headed screw driver or small metal blade into the slots for rotating the lens 608 to achieve laser calibration.

It will be understood that the embodiments described herein are not limited in their application to the details of the teachings and descriptions set forth, or as illustrated in the accompanying figures. Rather, it will be understood that the present embodiments and alternatives, as described and claimed herein, are capable of being practiced or carried out in various ways. Also, it is to be understood that words and phrases used herein are for the purpose of description and should not be regarded as limiting. The use herein of such words and phrases as “such as,” “comprising,” “e.g.,” “containing,” or “having” and variations of those words is meant to encompass the items listed thereafter, and equivalents of those, as well as additional items. The use of “including” (or, “include,” etc.) should be interpreted as “including but not limited to.”

Accordingly, the foregoing descriptions of several embodiments and alternatives are meant to illustrate, rather than to serve as limits on the scope of what has been disclosed herein. The descriptions herein are not intended to be exhaustive, nor are they meant to limit the understanding of the embodiments to the precise forms disclosed. It will be understood by those having ordinary skill in the art that modifications and variations of these embodiments are reasonably possible in light of the above teachings and descriptions.

What is claimed is:

1. A method of manufacturing a carpentry tool, comprising:
manufacturing a rectangular body/chassis;
positioning a plurality of bubble level inserts at opposite ends of the rectangular body/chassis;
positioning a center mound within the body/chassis and between the bubble level inserts;
manufacturing a front protruding part to have a flat side and an elliptical side;
locating a notch within the front protruding part at the center of the elliptical side;
locating a hole within the front protruding part at its center; and
attaching the flat side of the front protruding part to a short end of the rectangular surface of the body/chassis.

2. The method of claim 1, further comprising:
manufacturing the rectangular body/chassis from acrylonitrile butyl styrene (ABS).

3. The method of claim 1, further comprising:
positioning a plurality of male studs on a longitudinal side of the rectangular body/chassis.

4. The method of claim 1, further comprising:
tapping a female threaded aperture within the center mound, the female threaded aperture being compatible with a male member of a camera tripod.

5. The method of claim 1, further comprising:
locating a magnet inside the center of the body/chassis and mounting the magnet directly on a bottom plate rear surface of the body/chassis.

6. The method of claim 5, further comprising:
constructing the magnet from rare earth materials.

7. The method of claim 5, further comprising:
constructing the magnet from neodymium.

8. The method of claim 1, further comprising:
locating a second female-threaded UNC aperture on a surface of the stud-finder mechanism.

9. The method of claim 1, further comprising:
constructing the body/chassis to have a pre-fitted cavity for the magnet.

10. The method of claim 1, further comprising:
constructing the body/chassis to have two or more cavities for containing two or more bubble level mechanisms.

11. The method of claim 1, further comprising:
constructing the body/chassis to have two or more reinforcing ribs, using the reinforcing ribs to help pop out the body/chassis out of its mold.

12. The method of claim 1, further comprising:
locating ruler markings along one or more longitudinal sides of the stud-finder mechanism.

13. The method of claim 1, further comprising:
locating one or more male protrusions that stick out slightly from the surface of the body/chassis along both longitudinal sides of the stud-finder mechanism, the one or more male protrusions mating the stud finder mechanism with a laser mechanism.

14. The method of claim 1, further comprising:
constructing a laser mechanism separate from the stud-finder mechanism having a laser body/chassis, a laser engine, and a laser lens;
locating the laser lens facing external to the laser body/chassis and being near but in front of the laser engine.

15. The method of claim 14, further comprising:
the laser mechanism may be operated independently of the stud-finding mechanism, and vice versa.

16. The method of claim 14, further comprising:
constructing the laser body/chassis to further comprises a plurality of reinforcing ribs, a battery compartment, a push micro switch on the top of the laser to turn the laser on/off.

17. The method of claim 14, further comprising:
inserting the laser engine into the body/chassis using an assembly mechanism that lifts the various wiring components out of the way and makes it more accessible to be later routed and connected to the battery compartment.

18. The method of claim 17, further comprising:
routing the plurality of wires between the laser engine and the battery compartment after the above insertion.

19. The method of claim 1, further comprising:
constructing the bubble-levels to be water-based.

20. A method of operating a stud-finder mechanism, comprising:
a user swiping the stud-finder mechanism over an area of drywall;
the user feeling a magnetic pull when passing over a screw that is hidden behind the drywall in the stud;
using a first notch to mark a position of a stud using a pen or pencil;
pairing the stud-finder mechanism with a laser mechanism which projects a laser light suitable for visually determining a condition of level-ness; and
the pairing occurring through male protrusions located in a chassis of the stud-finder mechanism matching up and mating with female apertures located in a chassis of the laser mechanism.
